(19) United States
(12) Patent Application Publication
(10) Pub. No.: US 2016/0019803 A1
(43) Pub. Date: Jan. 21, 2016

(54) SYSTEM, METHOD AND COMPUTER-ACCESSIBLE MEDIUM FOR SCALABLE TESTING AND EVALUATION

(71) Applicant: NEW YORK UNIVERSITY, New York, NY (US)

(72) Inventors: PANAGIOTIS G. IPEIROTIS, New York, NY (US); MARIA CHRISTOFORAKI, Mountain View, CA (US)

(73) Assignee: New York University

(21) Appl. No.: 14/804,874

(22) Filed: Jul. 21, 2015

Related U.S. Application Data
(60) Provisional application No. 62/026,893, filed on Jul. 21, 2014.

(51) Int. Cl. G09B 7/00

(52) U.S. Cl. CPC G09B 7/00

(57) ABSTRACT

An exemplary system, method and computer-accessible medium can be provided that can be used, for example, for evaluating a test question(s) for a test(s), which can include receiving information related to a content(s), mapping the content(s) to a skill(s), and evaluating the content(s) as the test question(s) so as to test an ability of user(s) at the skill(s).

### CROSS-REFERENCE TO RELATED APPLICATION(S)

This application relates to and claims priority from U.S. Patent Application No. 62/026,893, filed on Jul. 21, 2014, the entire disclosure of which is incorporated herein by reference.

### FIELD OF THE DISCLOSURE

The present disclosure relates generally to online testing, and more specifically, to exemplary embodiments of an exemplary system, method and computer-accessible medium for online scalable testing and evaluation.

BACKGROUND INFORMATION

Currently, increasingly more skilled labor activities are being carried out online. By connecting workers and employers through computer-mediated marketplaces, online labor markets such as Amazon Mechanical Turk, oDesk and Mobileworks, can eliminate geographical restrictions, help participants find desirable jobs, guide workers through complex goals and better understand workers' abilities. Online labor markets offer participants the opportunity to chart their own careers, pursue work they find valuable, and do all of this at a scale that few companies can match today. Spurred by this revolution, it has predicted that remote work will be the norm rather than the exception within the next decade. (See, e.g., Reference 2). One major challenge in this setting can be to build skill assessment systems that can evaluate and certify the skills of workers in order to facilitate the job matching process. Online labor markets currently rely on two forms of assessment mechanisms (i) reputation systems and (ii) testing.

Online markets often rely on reputation systems for instilling trust in the participants. (See, e.g., References 3 and 14). However, existing reputation systems are better-suited for markets where participants can engage in a large number of transactions (e.g., selling of electronics, where a merchant can sell tens or hundreds of items in a short period of time). Online labor inherently suffers from data sparseness. Various work engagements require at least a few hours of work, and many can last for weeks or months. As a result, many participants have only minimal feedback ratings, which can be a very weak reputation signal. Unfortunately, the lack of reputation signals can create a cold-start problem. (See, e.g., Reference 12). Workers cannot get jobs because they do not have feedback, and therefore workers cannot get feedback that would help them to get a job. In a worst case scenario, such markets can become “markets for lemons” (see, e.g., Reference 1), forcing the departure of high-quality participants, leaving only low-quality workers as potential entrants. In offline labor markets, educational credentials can often be used to signal the quality of the participants and avoid the cold-start problem. (See, e.g., Reference 16). In global, online, markets, however, credentialing can be much trickier. Verifying educational background can be difficult, and knowledge of the quality of the educational institutions on a global scale can be limited.

Given the shortcomings of reputation systems, many online labor markets generally resort to using testing as means of assessment; offering their own certification mechanisms. The goal of these tests can be to verify/certify that a given worker indeed possesses a particular skill. For example, oDesk, eLance and Freelancer products facilitate workers to take online tests that can assess the competency of these contractors across various skills (e.g., Java, Photoshop, Accounting, etc.), and then facilitate the contractors to display the achieved scores and ranking in their profile. Similarly, crowdsourcing companies such as CrowdFlower and Mechanical Turk can certify the ability of contractors to perform certain tasks (e.g., photo moderation, content writing, translation, etc.), and can facilitate employers to restrict recruiting to the population of certified workers. Unfortunately, online certification of skills can still be problematic, with cheating being a big challenge. Since tests can be available online, they can often be “leaked” by some test takers, and the answers can become widely available on the web. FIG. 1 illustrates an exemplary number of web-sites 105 that contain solutions for the some of the popular tests available on oDesk, eLance and vWorker that were identified using simple web searches. Thus, the reliability of the tests for which answers can be easily available through a web search can be questionable.

Furthermore, it can be common, even for expert organizations, to create questions with errors or ambiguities, especially if the test questions have not been properly assessed and calibrated with relatively large samples of test takers. (See, e.g., Reference 17). At the same time, many people question the value of the existing tests (see, e.g., References 6, 7, 9, 11 and 13), as long-term predictors of performance, which can indicate that questions can be calibrated only for internal consistency (e.g., how predictive a question can be about the final test score) and not for external validity (e.g., how predictive the question can be for the long-term performance of the test taker). This question can be particularly acute for online labor markets, as there is little research that examines whether testing and certifications can actually be predictive of success in the labor market.

Crowdsourcing research has recently focused on techniques for getting crowd members to evaluate each other. (See, e.g., References 4 and 18). A hope is that peer assessment can lead to better learning outcomes as well. (See, e.g., Reference 10). Unfortunately, these conventional systems still have a large variance in final assessment scores, which makes them a poor match for certification and qualification.

Thus, it may be beneficial to provide an exemplary system, method and computer-accessible medium that can be, for example, more cheat-proof than existing tests, that can use test questions that can be closer to the real problems than a skill holder can be expected to solve, can assess the quality of the tests using real market-performance data, and which can overcome at least some of the deficiencies described herein above.

### SUMMARY OF EXEMPLARY EMBODIMENTS

An exemplary system, method and computer-accessible medium can be provided that can be used, for example, for evaluating a test question(s) for a test(s), which can include receiving information related to a content(s), mapping the content(s) to a skill(s), and evaluating the content(s) as the test question(s) so as to test an ability of a user(s) at the skill(s). The content(s) can be actively accepted, actively rejected, or re-evaluated as the test question(s) based on the evaluating procedure. The content(s) can be selected from a question/answer website(s). Before the content(s) can be evaluated, the content(s) can be transmitted to an editor(s), and can be received, from the editor(s), as an experimental test question(s) based on the content(s).

In some exemplary embodiments of the present disclosure, the evaluation procedure can be performed on the experimental test question. The evaluation procedure can include an endogenous metric(s) or an exogenous metric(s). The endogenous metric(s) can include a normalized value of a raw test score for each user that answers the experimental test question.

The exogenous metric(s) can include an attribute(s) of each user that answers the experimental test question. The experimental test question can be marked as a production test question. The evaluation procedure can be periodically performed on the production test question. It can be determined if the production test question can be an outlier.

In certain exemplary embodiments of the present disclosure, the evaluation procedure can be based on an Item Response Theory, which can be based on an Item Characteristic Curve. The Item Characteristic Curve can be based on a probability that a particular user having a particular ability will give a correct answer. The Item Response Curve can have a form of

$$P ( θ ) = c + \frac{d - c}{1 + {e}^{- a ( θ - b )}} ,$$

where c can be a probability of guessing a correct answer randomly for each question, d can be a highest possible probability of answering the question correctly, a can be a discrimination, and b can be a difficulty of the question. The evaluation procedure can be based on a Fisher information of P(θ).

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is an exemplary graph illustrating the number of URLs containing solutions to tests offered by various online marketplaces;

FIG. 2 is an exemplary diagram of the exemplary Scalable Testing and Evaluation Platform according to an exemplary embodiment of the present disclosure;

FIG. 3 is a set of exemplary images of a Q/A Thread transformation to a multiple choice Java Test Question according to an exemplary embodiment of the present disclosure;

FIGS. 4A and 4B are exemplary diagrams illustrating an exemplary 2PL item characteristic curve for different discrimination and difficulty values according to an exemplary embodiment of the present disclosure;

FIGS. 5A and 5B are exemplary diagrams illustrating an Item Characteristic Curve and information curves for an accepted versus a rejected experimental question for a 2PL item characteristic curve for different discrimination and difficulty values according to an exemplary embodiment of the present disclosure;

FIGS. 6A and 6B are exemplary diagrams of graphs illustrating examples of an accepted Production Question Analysis based on endogenous vs. exogenous metrics according to an exemplary embodiment of the present disclosure;

FIGS. 7A and 7B are exemplary diagrams of graphs illustrating examples of a rejected Production Question based on endogenous versus exogenous metrics according to an exemplary embodiment of the present disclosure;

FIGS. 8A and 8B are exemplary diagrams illustrating information curves for tests with questions generated by domain experts vs. new tests generated the exemplary with Scalable Testing and Evaluation Platform generated questions based on StackOverflow threads according to an exemplary embodiment of the present disclosure;

FIG. 9 is an exemplary flow chart of a method for evaluating a test question for a test according to an exemplary embodiment of the present disclosure; and

FIG. 10 is an illustration of an exemplary block diagram of an exemplary system in accordance with certain exemplary embodiments of the present disclosure.

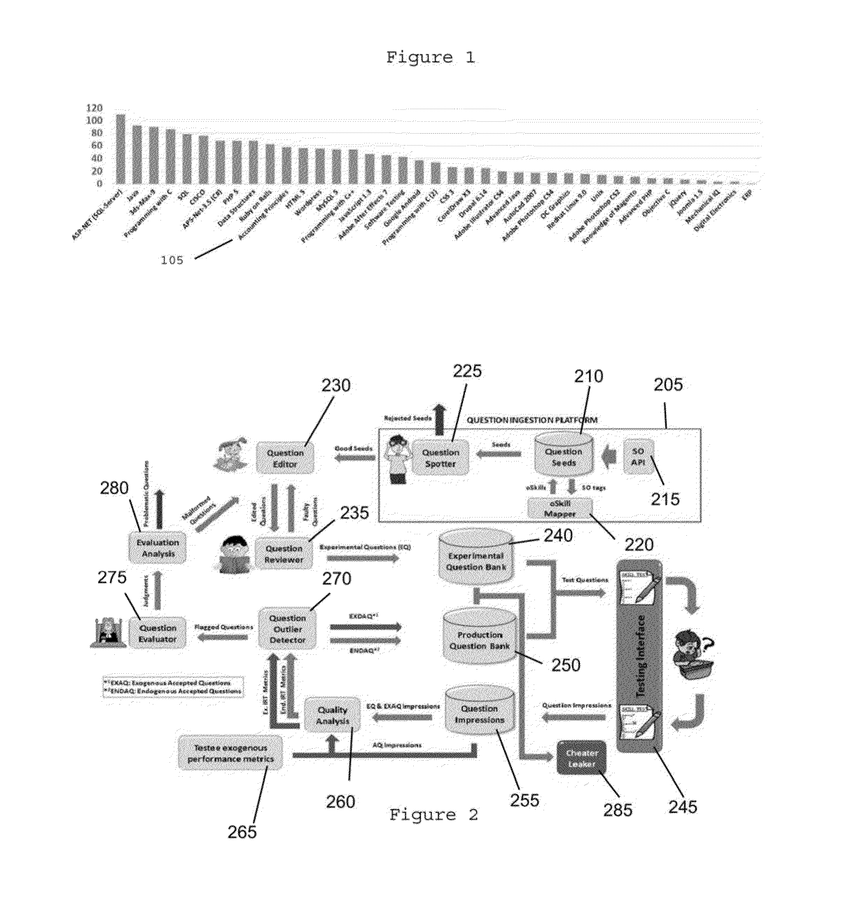

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DETAILED DESCRIPTION OF EXEMPLARY EMBODIMENTS

The exemplary Scalable Testing and Evaluation Platform (“STEP”), according to an exemplary embodiment of the present disclosure, can leverage content generated on popular question and answer (“Q/A”) sites, such as StackOverflow, and can use these questions and answers as a basis for creating test questions. The use of real-life questions can facilitate the generated test questions to be (i) relevant to a real-world problem, and (ii) continuously refreshed to replace questions that can be leaked or outdated. The exemplary system, method and computer-accessible medium, according to an exemplary embodiment of the present disclosure, can procedurally identify threads that can be promising for generating high quality assessment questions, and can use a crowdsourcing system to edit these threads and transform them into multiple choice test questions. To assess the quality of the generated questions, an exemplary Item Response Theory can be employed to examine not only how predictive each question can be regarding the internal consistency to the test (see, e.g., Reference 5), but it can also examine the correlation with future real-world market-performance metrics such as hiring rates, achieved wages, and so on, using the oDesk marketplace as an exemplary experimental testbed for evaluation.

### Exemplary System Overview

The exemplary STEP system, method and computer-accessible medium, according to an exemplary embodiment of the present disclosure, can include multiple components, the examples of which are shown in FIG. 2. Some exemplary components can depend on human input whereas others can operate automatically. The life of a question in the exemplary system, method and computer-accessible medium can start from, for example, extracting a promising thread from a Q/A site. The question can then be mapped to particular skills and evaluated with respect to its appropriateness to serve as a test question. Thereafter, the question can be edited, reviewed and forwarded to the pool of testing questions. For example, the question can collect answer-impressions from multiple users, which can then be used for its evaluation, using Item Response Theory metrics. Depending on the outcome of the evaluation the question can be rejected, re-evaluated or accepted. The accepted question metrics can be used to accurately evaluate users with respect to their expertise in a particular skill.

Exemplary Question Ingestion Component: The Question Ingestion Component of the STEP (e.g., question ingestion platform 205) can be used for collecting new “question seeds” 210 from online resources in order to keep the question pool wide-ranging and fresh. In particular, the Ingestion component 215 can communicate with the Q/A site, and fetch question and answer threads that can then be stored in a database together with a variety of metadata. A skill related to the question seed can be determined by the skill mapper 220. The question seeds can be the threads, and they can be labeled as “promising” or not by an automatic classification model. Threads cab be accepted or rejected by Question spotter (e.g., a classifier 225). The threads rejected by the classifier 225 can be removed from the question seed Bank, whereas the accepted ones can be forwarded to the editors 230 to be transformed into standardized questions.

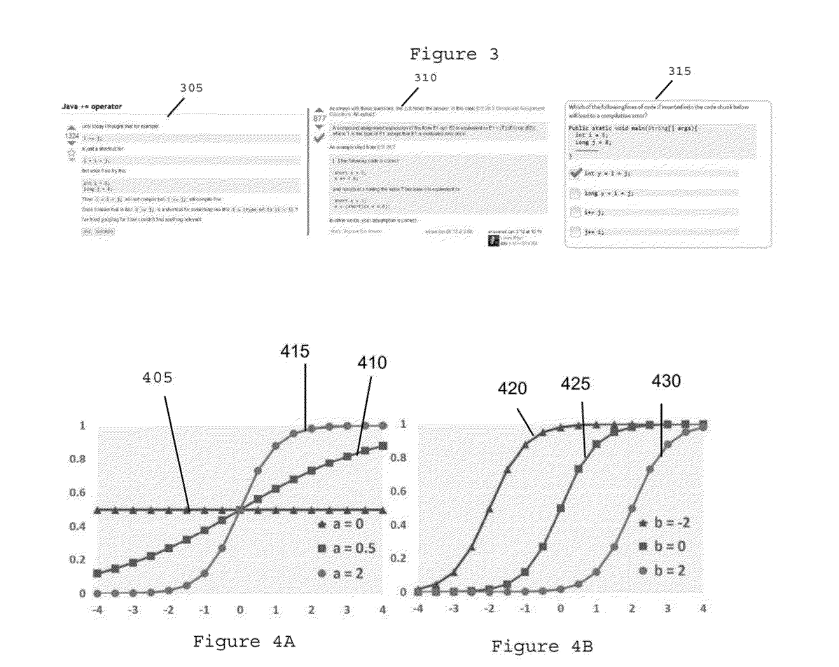

Exemplary Question Editor and Reviewer: Question Editors 230 can be human contractors with expertise on the topic of the test. The editor 230 can see the question and answer, and then reformulate the question to match the style of a test question, and adapt the answers to become choices in a multiple choice question. Once the question can be generated, then a Question Reviewer 235 can look at, or review, the question. The reviewer 235 may not have expertise with the topic but can have sufficient English and editing skills. The reviewer 235 can check for spelling, syntactical, or grammatical errors, and can ensure that the question formulated follows the guidelines suggested by the test standards, such as, for example, (i) question text length, (ii) answer option count, (iii) answer text length, (iv) vocabulary usage etc. Each question approved by the reviewer 235 can become Experimental, and can be committed to the Experimental Question Bank 240. Non-approved questions can be sent back to the Question Editor 230 for re-editing. FIG. 3 shows an illustration of the transformation of a seed to a skill test question. For example, in panel 305, a person (e.g., an online user) can pose a problem (e.g., a mathematical problem), for which the person cannot find an answer for. In panel 310, an expert can provide a response to the problem posed by the user. The answer and the posed problem can then be used by the exemplary system, method and computer-accessible medium to generate a text question in panel 315.

Exemplary Question Bank: The Experimental Question Bank 240 can store questions that can be created or provided by the Question Editor 230, but may not yet be evaluated. The experimental questions can be included in the tests (e.g., testing interface 245), but may only be about 10% to about 20% of the questions, and may not be used for the evaluation of the users. Thus, a test can be composed of a particular percentage (e.g., 10% or 20%, etc.) of experimental test questions from Experimental Question Bank 240 and a particular percentage (e.g., 80% or 90% etc.) from Production Question Bank 250. When the experimental questions receive enough answers, impressions about the questions can be generate by a Question Impression component 255, and then the questions can be forwarded for evaluation to the Quality Analysis component 260. The Production Question Bank 250 can also be used to store those questions that can be shown to users in tests, and that can be used for evaluation. Production Questions can also be evaluated periodically using the exemplary Quality Analysis component 260.

Exemplary Quality Analysis: The Quality Analysis Component 260 can be responsible for computing quality metrics for each question. Its functionality can be the quality evaluation of the test questions. The experimental questions can be evaluated using, for example, the “endogenous” metrics (e.g., whether the performance of the users in that question can correlate well the overall test score), and if they perform well, they can graduate into production. Production questions can also be evaluated periodically using exogenous metrics (e.g., testee exogenous performance metrics 265), which can determine how well they can predict the market performance of the users a few months after the test.

In addition to calculating the quality metrics, there can be an outlier detector (e.g., Question Outlier Detector 270) that can identify questions that behave differently than others. Such questions can be forwarded to human experts (e.g., Question Evaluator 275) who can examine, for example, through Evaluation Analysis component 280, whether the question has any technical error, ambiguity, etc. Problematic questions that can be corrected, can be edited and reintroduced in the system as experimental questions. Ambiguous and irrelevant questions can typically be discarded, as they can be difficult to fix. A question can also be discarded if no particular problem has been identified but the question still exhibits unusual behavior. A common cause for the problematic behavior can be that the question has been compromised. Even if the question can be correctly formulated, and can discriminate test takers with different ability levels, when it has leaked, a user's answer to this question may not be a reliable signal for the user's ability in the skill, which can lead to strange statistical behavior.

Exemplary Cheater Leaker: The “cheater leaker” component 280 can issue continuous queries against popular search engines, monitoring for leaked versions of the test questions. When a question can be located “in the wild,” a human can visit the identified web site and examine whether it indeed contains the question and the answers. A question can then be marked as “leaked”, and can be retired from the system. The leaked questions can then be released as practice questions and teaching/homework material for learning the skill. This component can also be used to ensure that when the question is originally created by the editor, it can be sufficiently reworded to avoid being located by simple web queries.

### Exemplary Question Generation Process

The exemplary system, method and computer-accessible medium, according to an exemplary embodiment of the present disclosure, can leverage existing Question Answering sites to generate seeds for new test questions. The volume of the available questions in sites such as Stack-Overflow can be both a blessing and a curse. The large number of questions can provide seeds for generating questions. However only a small fraction of the Q/A threads can be suitable for the generation of test questions, and the most promising threads have to be identified to avoid overwhelming the editors with false leads.

### Exemplary Stack Exchange

Stack Exchange (“SE”) is a network of more than a hundred sites with Question Answer threads on different areas ranging from software programming questions to, for example, Japanese Language and Photography questions. SE provides an application programming interface (“API”), and can provide programmatic access for downloading questions posted on these platforms along with all the answers and comments associated with them as well as a number of other semantically rich question, answer and comment features, like view count, up votes, down votes, author reputation scores etc. The downloaded questions can be separated into topics by leveraging the tags attached to each question.

The exemplary system, method and computer-accessible medium, according to an exemplary embodiment of the present disclosure, can focus on testing for technical skills and therefore focus on Stack Overflow. Stack Overflow is a popular site on Stack Exchange, and is “a question and answer site for professional and enthusiast programmers”. Such site currently has almost 3 million subscribed users, and more than 6 million questions associated with about 35,000 tags. Table 1 below shows 10 most popular topics which compose slightly more than 20% of the total volume of questions.

TABLE 1
Top-10 popular Stack Overflow tags

| Topic | Questions | Percentile (%) |
|---|---|---|
| C# | 508,194 | 3.08 |
| Java | 468,554 | 2.84 |
| PHP | 433,801 | 2.63 |
| Javascript | 433,707 | 2.63 |
| Android | 377,031 | 2.29 |
| Jquery | 355,800 | 2.16 |
| C++ | 222,599 | 1.35 |
| Python | 216,924 | 1.32 |
| HTML | 198,028 | 1.20 |
| mysql | 184,382 | 1.12 |

It may not be feasible or desirable to manually examine all threads to examine which threads can be the most promising for generating test questions. Thus, it can be preferable, according to an exemplary embodiment of the present disclosure, to automate the process of identifying good threads, and then use them as seeds for question generation. Preferably, the question can test something that can be confusing to users when they learn a skill, but clear for experts.

### Exemplary Question Spotter

A multi-stepped (e.g., three-stepped) approach can be followed for labeling threads as good or not good. As a tradeoff between speed and reliability of labeling, each thread can be assigned three labels that can mark whether it can be a good Q/A thread. For example, the labels (e.g., the three labels) can correspond to tradeoffs between the timeliness of creating the label and the corresponding reliability of the label that can indicate whether the thread can be a good one for test question generation. The first exemplary label can come through a crowd voting, where five workers can look at the Q/A thread, and vote on whether the thread can be promising for generating a test question. This label can be rather noisy, but it can be quick, and it can help quickly remove non-promising threads from consideration. Other exemplary labels can be generated by the quality analysis component, and can correspond to whether the question that was generated by the thread ended up being of high quality, and whether it had predictive value in predicting the future performance of the test-taker.

Using the exemplary labels described herein, an automatic classification models can be provided and/or generated that can that automatically assign a label to each incoming Q/A thread. Each Q/A thread can be endowed with a set of features, such as (i) number of views, (ii) number of votes for the question and each of the answers, (iii) the entropy of the vote distribution among the answers, (iv) the number of references to the thread, (v) the tags assigned to the text, (vi) the length of the question text and of the answers, (vii) the number of comments, (viii) the reputation of the members that asked the question and the answers, etc.

A classifier can be built using, for example, Random Forests, which can optimize for the precision of the results, and can minimize the number of false positives in the results (e.g., minimize the bad threads listed as good). The exemplary achieved precision can range from about 90% to about 98%, across a variety of technical topics. This measurement can be based on how many of the presented seeds are selected by the question editors and transformed into questions.

An exemplary qualitative assessment of the features used was performed to determine what makes a Q/A thread a good seed for a test question. The assessment determined that a large number of upvotes can be a negative predictor for suitability for the thread to generate a good test questions. Highly-voted questions tend to ask about arcane topics with little practical value. In contrast, threads with a large number of answers and high-entropy distribution of upvotes across the answers, can signal the existence of a topic that can be confusing to users, with many answers that can serve as “distractor answers”. (See, e.g., Reference 8). Further, question threads frequently visited by many users can indicate questions on common problems for a variety of expertise levels for the topic at hand. In addition, the number of incoming links to the question can be highly correlated with high-quality answers, while threads with very long answers may not be good for test-question generation, even if they get large number of upvotes.

### Exemplary Question Quality Evaluation

The exemplary Question Analysis component of the exemplary system, method and computer-accessible medium, according to an exemplary embodiment of the present disclosure, can generate a set of metrics to evaluate the quality of the questions in the Question Banks These exemplary metrics can be computed using standard methods from Item Response Theory (“IRT”), a field of psychometrics for evaluating the quality of tests and surveys to measure abilities, attitudes, etc. The prerequisite for analyzing a question (e.g., the “Item” in IRT) can be for the question to be answered by a sufficiently large number of test-takers. When the data is obtained, IRT can be used to examine how well the test question can measure the “ability” θ of a test-taker. Traditionally, the θ can be approximated by the score of the user in the overall test, and can be rather “endogenous.” In addition to the endogenous measure of ability, “exogenous” market performance metrics can also be used for measuring the ability θ of a test-taker as demonstrated in the market, and not just based on the test results.

Exemplary Basics of Item Response Theory

The first exemplary assumption in IRT can be that the test-takers have a single ability parameter θ, which can represent the subject's ability level in a particular field, and which customary, can be considered to have a N(0, 1) normal distribution, with the population mean having θ=0. The second assumption can be that items can be conditionally independent given an individual's ability. Given these two assumptions, each question can be characterized by the probability P(θ) that a user with an ability θ can give a successful answer to the question. This function P(θ) can be called Item Characteristic Curve (“ICC”) or Item Response Function (“IRF”) and can have the following general form:

$$P ( θ ) = c + \frac{d - c}{1 + {e}^{- a ( θ - b )}} \qquad ( 1 )$$

The parameter a can be called discrimination, and can quantify how well the question can discriminate between test-takers with different ability levels. Higher values can result in a steeper curve, which can illustrate that the probability of correctly answering can increase sharply with the ability of the test taker. The parameter b can be called difficulty. It can correspond to the value of θ where P(θ)=0.5, and can also be the inflection point of the curve. Higher values can illustrate that only high ability test-takers answer the question correctly. Further, c can be the probability of guessing the correct answer randomly for each question, and d can be the highest possible probability of answering a question correctly. For simplicity, c=0 for free-text answers or c=1/n for multiple choice questions, with n being the number of available answers, and set d=1.

FIGS. 4A and 4B illustrate exemplary graphs which can indicate how the ICC can change for different values of discrimination and difficulty. As illustrated in FIG. 4A, the question's difficulty can be set to zero and the lines can show the ICC for three discrimination values (e.g., line 405 for discrimination 0, line 410 for discrimination 0.5, and line 415 for discrimination 2). When the discrimination can be zero (e.g., line 405), the line can be flat, and it can be obvious that there may be no correlation between the test-taker ability and the probability of answering the question correctly. As illustrated in FIG. 4B, the question's discrimination can be set to 2, and the three lines can show the ICC for three difficulty values (e.g., line 420 for discrimination −2, line 425 for discrimination 0, and line 430 for discrimination 2). Smaller difficulty values can shift the steep part of the curve to the left, and can let test takers with lower ability levels have better chances of answering the question correctly.

An important additional metric to consider can be the Fisher information I(θ) of the P(θ) distribution. The Fisher information can be a way of measuring the amount of information that an observable random variable X can carry about an unknown parameter θ upon which the probability of X can depends. The Fisher information of a question can indicate, for example, how accurately the ability θ (e.g. the unknown parameter) can be measured for a user after observing the answer to the question (e.g. the observed random variable). This can be, for example:

$$I ( θ ) = {a}^{2} \frac{{e}^{- a ( θ - b )}}{{( 1 + {e}^{- a ( θ - b )} )}^{2}} \qquad ( 2 )$$

Highly discriminating items can have tall, narrow information functions, and they can measure, with accuracy, the θ value but over a narrow range. Less discriminating questions can provide less information but over a wider range. Highly discriminative questions can provide a lot of information about the ability of a user around the inflection point, as they can separate the test takers well, but may not provide much information in the flatter regions of the curve.

An important and useful property of Fisher information can be its additivity. The Fisher information of a test can be the sum of the information of all the questions in the test. Thus, when creating a test, questions with that have high I(θ) across a variety of θ values can be selected to be able to measure the ability θ across a variety of values. More questions that have high I(θ) for the regions of interest can be added in order to measure some regions more accurately.

### Exemplary Question Analysis Based on Endogenous Metrics

Following the paradigm of traditional IRT, the first quality analysis can use, as a measure of the ability θ, the test score of the test-taker, computed over only the production questions in the test, and not the experimental questions. The raw test scores for each user i can then be converted into a normalized value θᵢ, such that the distribution of scores can be a standard normal distribution. Once the ability scores θᵢ for each user i can be obtained, each question j can be analyzed. The answer of the user in each question can be binary, either correct or incorrect. Using the exemplary data, the ICC curve can be fit, and the discrimination a and the difficulty bⱼ for each question can be estimated.

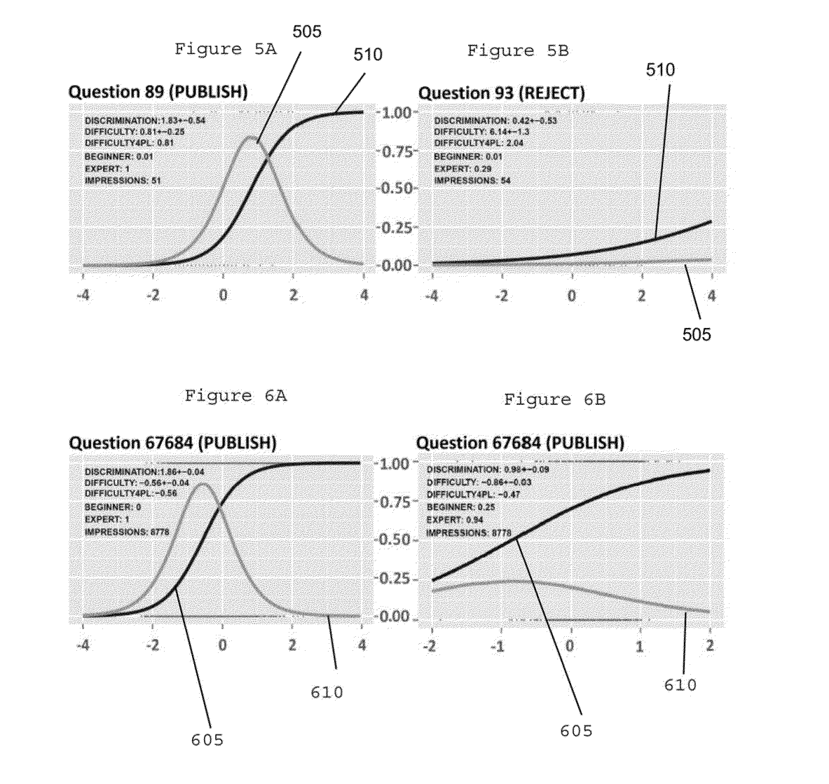

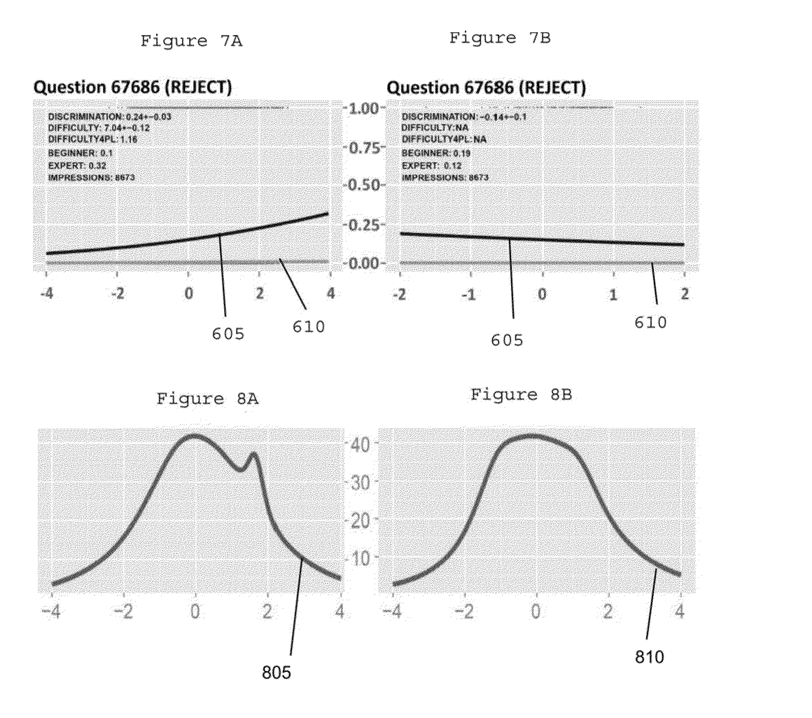

For an experimental question to move to a production question, the discrimination in the top-90% percentile across all questions can be used, and should be positive. FIGS. 5A and 5B show the ICC and information curves for two questions (e.g., curve 505 and curve 510). An accepted question can have a high discrimination value, and can also have a high Fisher information. A rejected question can typically have a low discrimination and a low Fisher information. When analyzing existing tests, questions with high, but negative, discrimination values can be observed. These questions can have an incorrect answer marked as correct, or were “trick” questions testing very arcane parts of the language. FIGS. 6A, 6B, 7A and 7B show the exemplary ICC and exemplary information curves of two questions relating to Java. For example, curve 605 of FIG. 6A illustrates the ICC curve and Curve 610 the information curve. The exemplary graphs of FIGS. 6A and 6B show a question with high discrimination and medium difficulty, whereas the exemplary graphs of FIGS. 7A and 7B illustrate a question with high difficulty and low discrimination.

### Exemplary Question Analysis Based on Exogenous Metrics

A common complaint about tests can be that they do not focus on topics that can be important “in the real world.” Thus, “exogenous” ability metrics can be used to represent the test-taker θs. Exogenous ability metrics can measure the success of the test-taker in the labor market, as opposed to the success while taking the test. Examples of these metrics can be the test takers average wage, hiring rate, the jobs that they have completed successfully. Using the exemplary exogenous metrics can make the evaluation of the questions more robust to cheating, and can more easily indicate which of the skills tested by the question can be important in the marketplace. For brevity, the exemplary results using the log of wages 3 months after the test can be used to represent the test taker's ability θ.

The questions may not exhibit the same degree of correlation with the exogenous user abilities compared to the endogenous ability (e.g. the user test-score itself). As indicated herein, FIG. 6A shows the exemplary ICC and information curves of the same question but computed using the exogenous ability metrics. The discrimination of the question that can be computed using the endogenous ability metrics can be a relatively high (e.g. about 0.98) discrimination, but still not as high as the discrimination computed using the exogenous metrics (e.g. about 1.86). The same can hold for the exemplary graphs illustrated in FIGS. 7A and 7B. Both Figures show a low quality question, with the discrimination computed by the exogenous ability metrics actually being negative. The exemplary pattern can hold across all questions that were examined. An implication can be that more test-takers can be needed to be able to robustly estimate the discrimination and difficulty parameters for each question.

The exemplary exogenous ability metric can have two objectives. First, the contractors and their ability can be understood to perform well in the marketplace. Second, which of the test questions can still be useful for contractor evaluation can be determined. For questions that can be leaked, or questions that may be outdated (e.g., deprecated features), the exogenous evaluation can show a drop of discrimination over time, providing evidence that the question should be removed or corrected.

### Exemplary Experimental evaluation

The exemplary approach for generating tests from Q/A sites can have the clear advantages of being able to generate new questions quickly as compared to the existing practice of using a “static” pool of test questions. However, there can be certain important questions when considering this approach: (i) How do the questions perform compared to existing test questions, and (ii) What can be the cost for generating these questions?

In order to evaluate the benefit of the exemplary system, method and computer-accessible medium, according to an exemplary embodiment of the present disclosure, a comparison can be made using a static question bank and generated test-questions with STEP for the following exemplary skills: PHP, Python, Ruby on Rails, CSS, HTML and Java. The skill testing interface of oDesk was used to facilitate the collection of responses to the exemplary questions by injecting a small number of them at-a-time to the oDesk skill-tests. The exemplary questions were not used for the oDesk user evaluation, but at least 100 responses were collected for each. Exogenous metrics of oDesk can also be accessed to evaluate the exemplary system, method and computer-accessible medium, according to an exemplary embodiment of the present disclosure. Thus, for each skill, there were existing tests that contained questions from a “static” question bank, generated by domain experts, and the new exemplary STEP test, which contained only questions generated by the exemplary STEP system, method and computer-accessible medium using StackOverflow threads.

For each of these two exemplary tests, the information curve for the test was computed by summing the information gain of all its questions. FIGS. 8A and 8B show the exemplary results as graphs for the Java test; the results were very similar for all the other skills that were experimented with (e.g., PHP, Python, Ruby on Rails, CSS, HTML, Java). FIG. 8A shows the exemplary information curve 805 for the test containing the “static question bank” questions. FIG. 8B shows the exemplary curve 810 of the information gain for the test containing the STEP-generated questions. The x-axis is the ability level of the test takers and the y-axis is the information of the test for the particular ability level. High information values can mean higher precision of the test when measuring the ability of a worker with a certain ability. Both tests behave similarly, indicating that the exemplary STEP questions can have the same quality on average as the questions that can be generated by domain experts.

How many of the questions in the exemplary two tests were able to pass the evaluation that used the exogenous ability (e.g. wage) as the ability metric were also examined. When evaluating the domain expert questions, about 87% of the questions were accepted, whereas the STEP questions have an about 89% acceptance rate. The numbers can be approximately equivalent, indicating that STEP can generate questions at the same level of quality, or even higher, than the existing solutions.

Given that the quality of the STEP tests can be equivalent to the existing tests that can be acquired from a question bank; the next question can be whether it can make financial sense to create questions using STEP. The cost of the question in STEP ranged from $3/question to $5/question, depending on the skill tested, with an average cost of $4/question. For the domain-expert questions, the cost per question was either a variable $0.25/question per user taking the test or $10 to buy the question. Therefore, it can also be financially preferable to use the STEP system, method and computer-accessible method to generate questions compared to using existing question banks In addition to being cheaper, STEP can also facilitate a continuous refreshing of the question bank, and can facilitate the retired questions to be used by current users as practice questions for improving their skills.

### Exemplary Discussion

The exemplary system, method and computer-accessible medium, according to an exemplary embodiment of the present disclosure, can leverage content from user-generated Question/Answering websites to continuously generate test questions, facilitating the tests to always be “fresh”, and minimizing the problem of question leakage that unavoidably leads to cheating. Item Response Theory can also be leveraged to perform quality control on the generated questions and, marketplace-derived metrics can be used to evaluate the ability of test questions to assess and predict the performance of contractors in the marketplace, which can make it even more difficult for cheating to have an actual effect in the results of the tests.

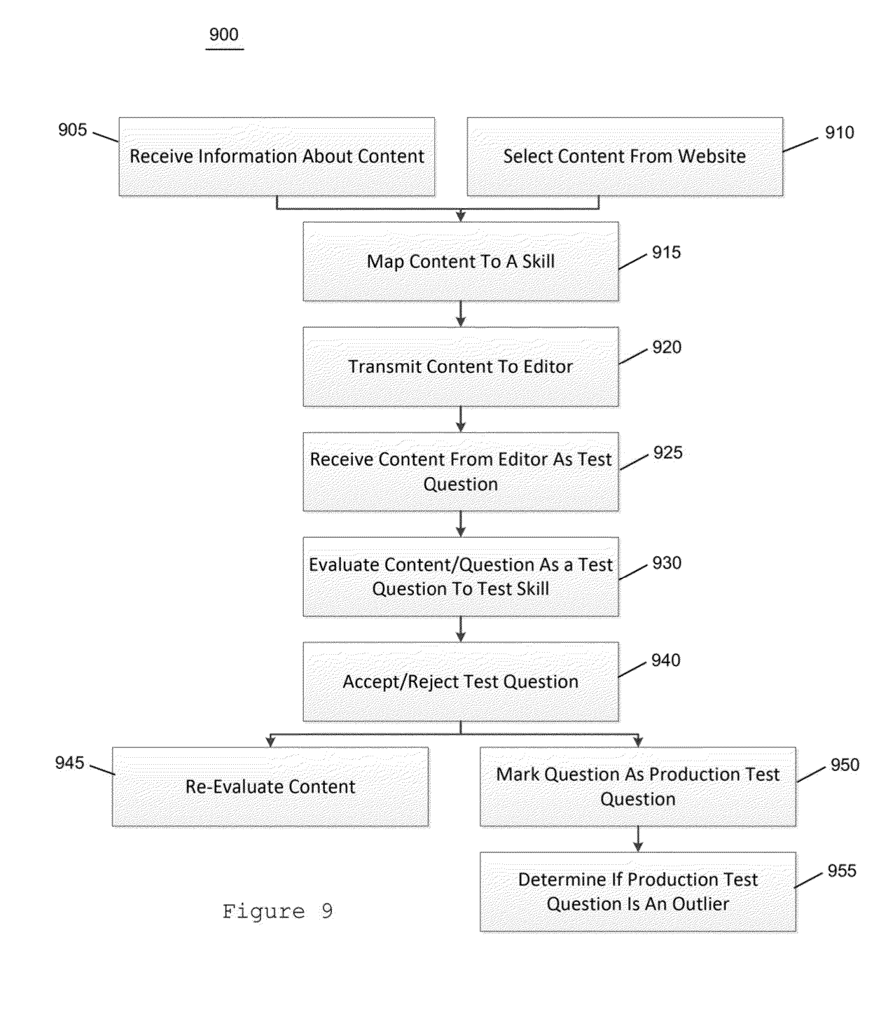

FIG. 9 shows an exemplary flow diagram of an exemplary method 900 for evaluating a test question for a test. For example, at procedure 905, information regarding content can be received. In addition, or in the alternative, the content can be selected from a website at procedure 910. At procedure 915, the content can be mapped to a particular skill. The content can then be sent to an editor at procedure 920 to be formulated as an experimental test question, which can be received by the exemplary system, method and computer-accessible medium at procedure 925. At procedure 930, the content/question can be evaluated (e.g., using a specifically-programmed computer) as a test question. This question can then be rejected or accepted at procedure 940. If the question is rejected, it can be re-evaluated at a later time at procedure 945. If the question is accepted, it can be marked as a production test question at procedure 950. At procedure 955, a determination can be made (e.g., using a specifically-programmed computer) as to whether the production test question is an outlier.

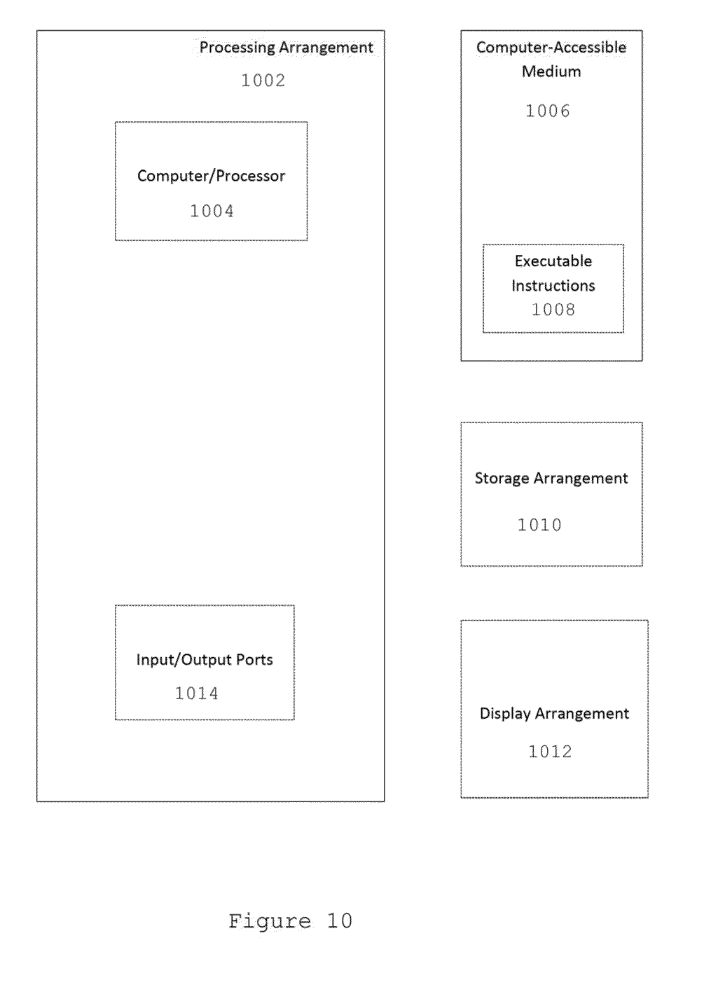

FIG. 10 shows a block diagram of an exemplary embodiment of a system according to the present disclosure. For example, exemplary procedures in accordance with the present disclosure described herein can be performed by a processing arrangement and/or a computing arrangement 1002. Such processing/computing arrangement 1002 can be, for example entirely or a part of, or include, but not limited to, a computer/processor 1004 that can include, for example one or more microprocessors, and use instructions stored on a computer-accessible medium (e.g., RAM, ROM, hard drive, or other storage device).

As shown in FIG. 10, for example a computer-accessible medium 1006 (e.g., as described herein above, a storage device such as a hard disk, floppy disk, memory stick, CD-ROM, RAM, ROM, etc., or a collection thereof) can be provided (e.g., in communication with the processing arrangement 1002). The computer-accessible medium 1006 can contain executable instructions 1008 thereon. In addition or alternatively, a storage arrangement 1010 can be provided separately from the computer-accessible medium 1006, which can provide the instructions to the processing arrangement 1002 so as to configure the processing arrangement to execute certain exemplary procedures, processes and methods, as described herein above, for example.

Further, the exemplary processing arrangement 1002 can be provided with or include an input/output arrangement 1014, which can include, for example a wired network, a wireless network, the internet, an intranet, a data collection probe, a sensor, etc. As shown in FIG. 10, the exemplary processing arrangement 1002 can be in communication with an exemplary display arrangement 1012, which, according to certain exemplary embodiments of the present disclosure, can be a touch-screen configured for inputting information to the processing arrangement in addition to outputting information from the processing arrangement, for example. Further, the exemplary display 1012 and/or a storage arrangement 1010 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following references are hereby incorporated by reference in their entirety.

[1] Akerlof, G. A. 1970. The market for “lemons”: Quality uncertainty and the market mechanism. The quarterly journal of economics 488-500.

[2] Davies, A.; Fidler, D.; and Gorbis, M. 2011. Future work skills 2020. Institute for the Future for University of Phoenix Research Institute.

[3] Dellarocas, C. 2003. The digitization of word of mouth: Promise and challenges of online feedback mechanisms. Management Science 49:1407-1424.

[4] Dow, S.; Kulkarni, A.; Klemmer, S.; and Hartmann, B. 2012. Shepherding the crowd yields better work. In Proceedings of the ACM 2012 Conference on Computer Supported Cooperative Work, CSCW '12, 1013-1022. New York, N.Y., USA: ACM.

[5] Embretson, S. E., and Reise, S. P. 2000. Item response theory. Psychology Press.

[6] Fleming, J., and Garcia, N. 1998. Are standardized tests fair to african americans?: Predictive validity of the sat in black and white institutions. Journal of Higher Education 471-495.

[7] Geiser, S., and Santelices, M. V. 2007. Validity of high-school grades in predicting student success beyond the freshman year: High-school record vs. standardized tests as indicators of four-year college outcomes. Technical report, University of California—Berkeley.

[8] Guttman, L., and Schlesinger, I. 1967. Systematic construction of distractors for ability and achievement test items. Educational and Psychological Measurement.

[9] Jensen, A. R. 1980. Bias in mental testing. ERIC.

[10] Kulkarni, C.; Wei, K. P.; Le, H.; Chia, D.; Papadopoulos, K.; Cheng, J.; Koller, D.; and Klemmer, S. 2013. Peer and self-assessment in massive online classes. Computer-Human Interaction (39).

[11] Newmann, F. M.; Bryk, A. S.; and Nagaoka, J. K. 2001. Authentic intellectual work and standardized tests: Conflict or coexistence? Consortium on Chicago School Research Chicago.

[12] Pallais, A. 2013. Inefficient hiring in entry-level labor markets. Technical report, National Bureau of Economic Research.

[13] Popham, W. J. 1999. Why standardized tests don't measure educational quality. Educational Leadership 56:8-16.

[14] Resnick, P.; Kuwabara, K.; Zeckhauser, R.; and Friedman, E. 2000. Reputation systems. Communications of the ACM 43 (12):45-48.

[15] Ronald K. Hambleton, Hariharan Swaminathan, H. J. R. 1991. Fundamentals of Item Response Theory. SAGE Publications, 3 edition.

[16] Spence, M. 1973. Job market signaling. The quarterly journal of Economics 87 (3):355-374.

[17] Wingersky, M. S., and Cook, L. L. 1987. Specifying the characteristics of linking items used for item response theory item calibration. Educational Testing Service.

[18] Zhu, H.; Dow, S. P.; Kraut, R. E.; and Kittur, A. 2014. Reviewing versus doing: Learning and performance in crowd assessment. In Proceedings of the ACM 2014 Conference on Computer Supported Cooperative Work. ACM.

What is claimed is:

1. A non-transitory computer-accessible medium having stored thereon computer-executable instructions for evaluating at least one test question for at least one test, wherein, when a computer arrangement executes the instructions, the computer arrangement is configured to perform procedures comprising:
receiving information related to at least one content;
mapping the at least one content to at least one skill; and
evaluating the at least one content as the at least one test question so as to test an ability of at least one user at the at least one skill.

2. The computer-accessible medium of claim 1, wherein the computer arrangement is further configured to actively accept the at least one content as the at least one test question based on the evaluating procedure.

3. The computer-accessible medium of claim 1, wherein the computer arrangement is further configured to actively reject the at least one content as the at least one test question based on the evaluating procedure.

4. The computer-accessible medium of claim 3, wherein the computer arrangement is further configured to re-evaluate the at least one content as the at least one test question after the at least one content has been rejected.

5. The computer-accessible medium of claim 1, wherein the computer arrangement is further configured to select the at least one content from at least one question/answer website.

6. The computer-accessible medium of claim 1, wherein, before the at least one content is evaluated, the computer arrangement is further configured to transmit the at least one content to at least one editor, and receive, from the at least one editor, at least one experimental test question based on the at least one content.

7. The computer-accessible medium of claim 6, wherein the evaluation procedure is performed by the computer arrangement on the experimental test question.

8. The computer-accessible medium of claim 6, wherein the evaluation procedure includes at least one of at least one endogenous metric or at least one exogenous metric performed by the computer arrangement.

9. The computer-accessible medium of claim 8, wherein the at least one endogenous metric includes a normalized value of a raw test score for each further user that answers the experimental test question.

10. The computer-accessible medium of claim 8, wherein the at least one exogenous metric includes at least one attribute of each further user that answers the experimental test question.

11. The computer-accessible medium of claim 7, wherein the computer arrangement is further configured to mark the experimental test question as a production test question.

12. The computer-accessible medium of claim 11 wherein the computer arrangement is further configured to periodically perform the evaluation procedure on the production test question.

13. The computer-accessible medium of claim 11, wherein the computer arrangement is further configured to determine if the production test question is an outlier.

14. The computer-accessible medium of claim 6, wherein the evaluation procedure is based on an Item Response Theory.

15. The computer-accessible medium of claim 14, wherein the Item Response Theory is based on an Item Characteristic Curve.

16. The computer-accessible medium of claim 15, wherein the Item Characteristic Curve is based on a probability that a particular user having a particular ability will give a correct answer.

17. The computer-accessible medium of claim 15, wherein the Item Response Curve has a form of
$$P ( θ ) = c + \frac{d - c}{1 + {e}^{- a ( θ - b )}} ,$$
where c is a probability of guessing a correct answer randomly for each question, d is a highest possible probability of answering the question correctly, a is a discrimination, and b is a difficulty of the question.

18. The computer-accessible medium of claim 17, wherein the evaluation procedure is based on a Fisher information of P(θ).

19. A method for evaluating at least one test question for at least one test, comprising:
receiving information related to at least one content;
mapping the at least one content to at least one skill; and
using a computer hardware arrangement, evaluating the at least one content as the at least one test question so as to test an ability of at least one user at the at least one skill.

20. A system for evaluating at least one test question for at least one test, comprising:
a computer hardware arrangement configured to:
receive information related to at least one content;
map the at least one content to at least one skill; and
evaluate the at least one content as the at least one test question so as to test an ability of at least one user at the at least one skill.
